(19) United States
(12) Patent Application Publication
(10) Pub. No.: US 2014/0268734 A1
(43) Pub. Date: Sep. 18, 2014

(54) LIGHT-EMITTING DIODE MODULE LAMP WITH ADJUSTABLE CHROMATICITY

(71) Applicants: CHEN-HAO CHANG, New Taipei City (TW); CHIH-JU HUNG, Taipei City (TW)

(72) Inventors: CHEN-HAO CHANG, New Taipei City (TW); CHIH-JU HUNG, Taipei City (TW)

(21) Appl. No.: 14/028,636

(22) Filed: Sep. 17, 2013

(30) Foreign Application Priority Data
Mar. 12, 2013 (TW) 102204502

(51) Int. Cl. F21K 99/00

(52) U.S. Cl. CPC F21K 9/50
USPC 362/231

(57) ABSTRACT

A light-emitting diode (LED) module lamp with adjustable chromaticity is provided. The LED module lamp is formed by at least one set of second module including a plurality of LED modules, namely a first LED module to an n^{th} LED module. Each of the LED modules includes a plurality of LEDs having visible spectrum chromaticities. That is, a first chromaticity LED C₁ to an n^{th} chromaticity LED Cₙ form a structure in a cyclic arrangement. The second module array is:

$$[ \begin{matrix}{C}_{1} & {C}_{2} & {C}_{3} & & … & {C}_{n - 1} & {C}_{n} \\ {C}_{2} & {C}_{3} & {C}_{4} & … & … & {C}_{n} & {C}_{1} \\ {C}_{3} & {C}_{4} & … & … & {C}_{n} & {C}_{1} & {C}_{2} \\ … & … & … & … & … & … & … \\ {C}_{n} & {C}_{1} & … & … & … & {C}_{n - 2} & {C}_{n - 1}\end{matrix} ] ,$$

where the first to n^{th} columns are independently connected in series.

This application claims the benefit of Taiwan application Serial No. 102204502, filed Mar. 12, 2013, the disclosure of which is incorporated by reference herein in its entirety.

### TECHNICAL FIELD

The present invention relates to a light-emitting diode (LED), and more particularly to an LED module lamp with adjustable chromaticity.

### BACKGROUND

In the prior art, an LED lamp is formed by combining red, blue and green LEDs in a single module lamp. The single module lamp forms into a single chroma LED module lamp through a pulse current provided by a pulse modulator. Alternatively, several of the single module lamp may be connected in parallel to generate a plurality of LED lamps with monochromaticity or a constant chromaticity. To control the LEDs for diversified chromaticities, a sophisticated pulse modulator is usually required.

### SUMMARY

A light-emitting diode (LED) module lamp with adjustable chromaticity is provided. The LED module lamp is formed by at least one set of second module repeatedly connected in series. The second module comprises a plurality of LED modules, namely a first LED module to an n^{th} LED module. Each of the LED modules comprises a plurality of LEDs having visible spectrum chromaticities, and is formed by a structure in a cyclic arrangement from a first chromaticity LED C₁ to an nth chromaticity LED Cₙ. A chromaticity sequence of the LEDs of the first LED module is the first chromaticity LED C₁, the second LED chromaticity LED C₂, . . . , the (n−1)^{th} chromaticity LED Cₙ₋₁, and the nth chromaticity LED Cₙ; the chromaticity sequence of the first LED module is a first column: └C₁, C₂, C₃, C₄, . . . , Cₙ₋₁, Cₙ ┘. A chromaticity sequence of the LEDs of the second LED module is the second chromaticity LED C₂, the third LED chromaticity LED C₃, . . . , the (n−1)^{th} chromaticity LED Cₙ₋₁, the nth chromaticity LED Cₙ, and the first chromaticity LED C₁; the chromaticity sequence of the second LED module is a second column: └C₂, C₃, C₄, . . . , Cₙ₋₁, Cₙ, C₁┘. A chromaticity sequence of the LEDs of the n^{th} LED module is the n^{th} chromaticity LED Cₙ, the first chromaticity LED C₁, the second LED chromaticity LED C₂, the third LED chromaticity LED C₃, . . . , and the (n−1)^{th} chromaticity LED Cₙ₋₁; the chromaticity sequence of the n^{th} LED module is an n^{th} column: └Cₙ, C₁, C₂, C₃, C₄, . . . Cₙ₋₂, Cₙ₋₁┘. A combination array (n×n) of the first LED module, the second LED module, the third LED module, to the n^{th} LED module of the second module is:

$$[ \begin{matrix}{C}_{1} & {C}_{2} & {C}_{3} & & … & {C}_{n - 1} & {C}_{n} \\ {C}_{2} & {C}_{3} & {C}_{4} & … & … & {C}_{n} & {C}_{1} \\ {C}_{3} & {C}_{4} & … & … & {C}_{n} & {C}_{1} & {C}_{2} \\ … & … & … & … & … & … & … \\ {C}_{n} & {C}_{1} & … & … & … & {C}_{n - 2} & {C}_{n - 1}\end{matrix} ]$$

The first to the n^{th} columns are respectively connected in series, and have equal total rated operating voltages, respectively. That is, the total rated operating voltages are equal to the operating voltages of the C₁ to Cₙ chromaticity LEDs added together, respectively. The chromaticity LEDs C₁ to Cₙ at the first column are sequentially connected in series as one group, the chromaticity LEDs C₂ to Cₙ₋₁, Cₙ and C₁ at the second column are sequentially connected in series as one group, the chromaticity LEDs C₃ to Cₙ and Cₙ₋₁ at the third column are sequentially connected in series as one group, and the chromaticity LEDs Cₙ, C₁, C₂ to Cₙ₋₂ and Cₙ₋₁ in the n^{th} column are sequentially connected in series as one group.

### BRIEF DESCRIPTION OF THE DRAWINGS

FIG. 1 is a schematic diagram of an LED module lamp with adjustable chromaticity according to a first embodiment.

FIG. 2 is a schematic diagram of PMWs combined with the first embodiment.

FIG. 3 is a schematic diagram of a first luminance chromaticity of a work period of a first LED according to the first embodiment.

FIG. 4 is a schematic diagram of a second luminance chromaticity of a work period of a second LED according to the first embodiment.

FIG. 5 is a schematic diagram of a third luminance chromaticity of a work period of a third LED according to the first embodiment.

FIG. 6 is a schematic diagram of controllers and PWMs combined with the first embodiment.

FIG. 7 is a schematic diagram of a first intensity of a work period of a first LED module and current combinations according to the first embodiment.

FIG. 8 is a schematic diagram of a second intensity of a work period of a second LED module and current combinations according to the first embodiment.

FIG. 9 is a schematic diagram of a third intensity of a work period of a third LED module and current combinations according to the first embodiment.

FIG. 10 is a schematic diagram of an LED module lamp with adjustable chromaticity according to a second embodiment.

FIG. 11 is a schematic diagram of PMWs combined with the first embodiment.

FIG. 12 is a schematic diagram of a first luminance chromaticity of a work period of a first LED according to the second embodiment.

FIG. 13 is a schematic diagram of a second luminance chromaticity of a work period of a second LED according to the second embodiment.

FIG. 14 is a schematic diagram of a third luminance chromaticity of a work period of an n^{th} LED according to the second embodiment.

FIG. 15 is a schematic diagram of controllers and PWMs combined with the second embodiment.

FIG. 16 is a schematic diagram of a first intensity of a work period of a first LED module and current combinations according to the second embodiment.

FIG. 17 is a schematic diagram of a second intensity of a work period of a second LED module and current combinations according to the second embodiment.

FIG. 18 is a schematic diagram of a third intensity of a work period of an n^{th} LED module and current combinations according to the second embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

FIG. 1 shows an LED module lamp 9 with adjustable chromaticity according to a first embodiment of the present invention. The LED module lamp 9 is formed by repeatedly connecting at least one set of first module 21 in series. The first module 21 comprises a first LED module 11, a second LED module 12 and a third LED module 13. The first LED module 11 sequentially comprises a red LED 41, a green LED 42 and a blue LED 43. The second LED module 12 sequentially comprises the green LED 42, the blue LED 43 and the red LED 41. The third LED module 13 sequentially comprises the blue LED 43, the red LED 41 and the green LED 42. Further, an LED output of the first LED module 11 is connected to an LED input end of the second LED module 12, and an LED output end of the second LED module 12 is connected to an input end of the third LED module 13 to form a serial connection structure. An output end of the red LED 41 of the first LED module 11 is connected to an input end of the green LED 42 of the second LED module 12, and an output end of the green LED 42 of the second LED module 12 is connected to an input end of the blue LED 43 of the third LED module 13 to form a serial connection. An output end of the green LED 42 of the first LED module 11 is connected to an input end of the blue LED 43 of the second LED module 12, and an output end of the blue LED 43 of the second LED module 12 is connected to an input end of the red LED 41 of the third LED module 13 to form a serial connection. An output end of the blue LED 43 of the first LED module 11 is connected to an input end of the red LED 41 of the second LED module 12, and an output end of the red LED 41 of the second LED module 12 of the second LED module 12 is connected to an input end of the green LED 42 of the third LED module 13 to form a serial connection.

Referring to the first embodiment shown in FIG. 1, the at least one first module 21 comprises: a starting terminal, which is the input end of the first module 21 and is connected to a first voltage 31; and an ending terminal, which is the output end of the first module 21 and is connected to a ground potential 32. When the first LED module 11 is connected in series to the first LED module 11 and sequentially connected in series to the third LED module 13, a total potential of a power supply is the same. The total potential is the potentials of the green LED 42, the red LED 41 and the blue LED 43 of the first LED module 11, the first LED module 11, and the third LED module 13 added together, respectively.

As shown in FIG. 2, the first embodiment comprises three pulse width modulators (PWMs) 51. Each of the PWMs 51 has a second end connected to the ground potential 32, and a first end connected to the output end of the first module 21 as the ending terminal. The output end of the first module 21 serving as the ending terminal is an independent output terminal of the three modules connected in series, respectively. Work periods of the three PWMs 51 are also independent, and are an adjustable range of 0% to 100%.

As shown in FIG. 6, the first embodiment of the present invention comprises three controllers 52. Each of the controllers 52 has one end connected to the ground potential 32, and the other end connected to the second end of the corresponding PWM 52. The controllers are constant voltage controllers, constant current controllers, or constant voltage and constant current controllers. A control current of the three controllers can be independently adjusted.

In the first embodiment of the present invention, the red LED 41, the green LED 42 and the blue LED 43 of the first LED module 11, through different work period combinations of the three PWMs 51, generate a first luminance chromaticity in a first period T1, as shown in FIG. 3. The red LED 41, the green LED 42 and the blue LED 43 of the second LED module 12, through different work period combinations of the PWMs 52, generate a second luminance chromaticity in the first period T1, as shown in FIG. 4. The red LED 41, the green LED 42 and the blue LED 43 of the third LED module 13, through different work period combinations of the PWMs 52, generate a third luminance chromaticity in the first period T1, as shown in FIG. 5.

In the first embodiment of the present invention, the red LED 41, the green LED 42 and the blue LED 43 of the first LED module 11, through different operating current combinations of the three PWMs 51, generate a first luminance intensity in the first period T1, as shown in FIG. 7. The red LED 41, the green LED 42 and the blue LED 43 of the second LED module 12, through different operating current combinations of the PWMs 52, generate a second luminance intensity in the first period T1, as shown in FIG. 8. The red LED 41, the green LED 42 and the blue LED 43 of the third LED module 13, through different operating current combinations of the PWMs 52, generate a third luminance intensity in the first period T1, as shown in FIG. 9. A second period T2 is a repetition of the first period T1. In the present invention, period changes of chromaticities are controlled through different combinations of a plurality of periods. More specifically, the three PWMs control the work periods of a plurality of periods are controlled to generate an LED module lamp 9 with adjustable chromaticity capable of automatically changing between various chromaticities.

As shown in FIG. 10, in a second embodiment of the present invention, the LED module lamp 9 with adjustable chromaticity is formed by a plurality of LEDs having visible spectrum chromaticities disposed in a cyclic arrangement. The LED module lamp 9 with adjustable chromaticity comprises at least one second module 22 repeatedly connected in series. The second module 22 comprises a plurality of LED modules, which are the first LED module 11 to an n^{th} LED module 19. Each of the LED modules comprises a plurality of LEDs having visible spectrum chromaticities sequentially disposed in a cyclic arrangement. The LEDs having visible spectrum chromaticities comprise a first chromaticity LED C₁, a second chromaticity LED C₂, . . . , to an (n−1)^{th} chromaticity LED Cₙ₋₁, and an nth chromaticity LED Cₙ. Based on a corresponding application of substantial characteristics of the first embodiment, the second embodiment of the present invention further comprises a plurality of LEDs having visible spectrum chromaticities sequentially disposed in a cyclic arrangement. Further, the first LED module 11, the second LED module 12 and the third LED module 13 are not limited to the three primary colors of the red LED 41, the green LED 42 and the blue LED 43.

A chromaticity sequence of the LEDs of the first LED module 11 is sequentially the first chromaticity LED C₁, the second chromaticity LED C₂, . . . , to the (n−1)^{th} chromaticity LED Cₙ₋₁ and the nth chromaticity LED Cₙ. Thus, the chromaticity sequence of the first LED module 11 is simplified to the first column as:

└C₁,C₂,C₃,C₄, . . . ,Cₙ₋₁,Cₙ┘ (1)

In the above, C₁ represents the first chromaticity LED, C₂ represents the second chromaticity LED, . . . , Cₙ₋₁ represents the (n−1)^{th} chromaticity LED, and Cₙ represents the n^{th} chromaticity LED.

A chromaticity sequence of the LEDs of the second LED module 11 is sequentially the second chromaticity LED C₂, the third chromaticity LED C₃, . . . , the (n−1)^{th} chromaticity LED Cₙ₋₁, the nth chromaticity LED Cₙ, and the first chromaticity LED C₁. Thus, the chromaticity sequence of the second LED module 12 is simplified to a second column as:

└C₂,C₃,C₄, . . . ,Cₙ₋₁,Cₙ,C₁┘ (2)

In the above, C₂ represents the second chromaticity LED, C₃ represents the third chromaticity LED, . . . , Cₙ₋₁ represents the (n−1)^{th} chromaticity LED, Cₙ represents the nth chromaticity LED, and C₁ represents the first chromaticity LED.

In summary, in the present invention, a chromaticity sequence of a plurality of LEDs of an n^{th} LED module 19 is the n^{th} chromaticity LED Cₙ, the first chromaticity LED C₁, the second chromaticity LED C₂, the third chromaticity LED C₃, . . . , and the (n−1)^{th} chromaticity LED Cₙ₋₁. Thus, the chromaticity sequence of the n^{th} LED module 19 is simplified to an n^{th} column as:

└Cₙ,C₁,C₂,C₃,C₄, . . . Cₙ₋₂,Cₙ₋₁┘ (n)

In the above, Cₙ represents the n^{th} chromaticity LED, C₁ represents the first chromaticity LED, C₂ represents the second chromaticity LED, C₃ represents the third chromaticity LED, . . . , and Cₙ₋₁ represents the (n−1)^{th} chromaticity LED.

According to the chromaticity LED sequence structure of the LED module lamp 9 with adjustable chromaticity, a combination matrix (n×n) of the first LED module 11, the second LED module 12, the third LED module 13, the fourth LED module 14, . . . , the (n−1)^{th} LED module 18, and the n^{th} LED module 19 is described as below:

$$[ \begin{matrix}{C}_{1} & {C}_{2} & {C}_{3} & & … & {C}_{n - 1} & {C}_{n} \\ {C}_{2} & {C}_{3} & {C}_{4} & … & … & {C}_{n} & {C}_{1} \\ {C}_{3} & {C}_{4} & … & … & {C}_{n} & {C}_{1} & {C}_{2} \\ … & … & … & … & … & … & … \\ {C}_{n} & {C}_{1} & … & … & … & {C}_{n - 2} & {C}_{n - 1}\end{matrix} ] \qquad second module 22$$

The above combination array expresses the second module 22 of the LED module lamp 9 with adjustable chromaticity. The combination array is sequentially a first list/the first LED module 11, a second list/the second LED module 12, a third list/the third LED module 13, . . . , an (n−1)^{th} list/the (n−1)^{th} LED module 18, and an (n)^{th} list/the (n)^{th} LED 19. In the serial mode of the voltage supplies, the power supplies are connected in series according to respectively columns, with the first chromaticity LED in the column providing the voltage supply, and the last chromaticity LED in the column being connected to the ground. The chromaticity LEDs C₁ to Cₙ at the first column are sequentially connected in series as one group, the chromaticity LEDs C₂ to Cₙ₋₁, Cₙ and C₁ at the second column are sequentially connected in series as one group, the chromaticity LEDs C₃ to Cₙ and Cₙ₋₁ at the third column are sequentially connected in series as one group, and the chromaticity LEDs Cₙ, C₁, C₂ to Cₙ₋₂ and Cₙ₋₁ in the n^{th} column are sequentially connected in series as one group. The at least one set of second module 22 comprises an input end serving as the starting terminal connected to the first voltage 31, and an output end serving as an ending terminal connected to the ground potential 32.

In the second embodiment of the present invention, the first chromaticity LED C₁ to the n^{th} chromaticity LED Cₙ have a rated operating voltage, respectively. Through the structure in a cyclic arrangement of the present invention, the first to n^{th} columns are individually connected in series and have an equal total rated operating voltage, respectively. That is, the total rated operating voltages are equal to the operating voltages of the C₁ to Cₙ chromaticity LEDs added together, respectively. As such, when the LED module lamp is implemented to applications from architectural landscapes to commercial models, no additional circuits are required. More specifically, as the plurality of second modules 22 can be readily connected in series while providing equal total operating voltages of the independent serial connections, an issue of requiring an additional circuit due to different operating voltages may be eliminated.

As shown in FIG. 11, the second embodiment of the present invention comprises an n number of PWMs 51. Each of the PWMs 51 has a second end connected to a ground potential, and a first end connected to the output end of the second module 22 serving as the ending terminal. The output end of the second module 22 serving as the ending terminal is the output end of the n sets of independent serial connections. Word periods of the three PWMs 51 are also independent, and are an adjustable range of 0% to 100%.

As shown in FIG. 15, the second embodiment of the present invention comprises an n number of controllers 52. Each of the controllers 52 has one end connected to a ground potential, and the other end connected to the second end of the corresponding PWM 52. The controllers are constant voltage controllers, constant current controllers, or constant voltage and constant current controllers. A control current of the three controllers can be independently adjusted.

As shown in FIG. 12, the first LED C₁ to the nth LED Cₙ, └C₁, C₂, C₃, C₄, . . . , Cₙ₋₁, Cₙ┘, through different work period combinations of the n number of PWMs 51, generate a first luminance chromaticity in a first period T1. As shown in FIG. 13, the second LED C₂ to the first LED C₁, └C₂, C₃, C₄, . . . , Cₙ₋₁, Cₙ, C₁┘, through different work period combinations of the n number of PWMs 51, generate a second luminance chromaticity in the first period T1, and so forth. As shown in FIG. 14, the n^{th} LED Cₙ to the first LED Cₙ₋₁, └Cₙ, C₁, C₂, C₃, C₄, . . . Cₙ₋₂, Cₙ₋₁┘, through different work period combinations of the n number of PWMs 51, generate an nth luminance chromaticity in the first period T1.

Therefore, in the second embodiment of the present invention, through different combinations of different work period combinations of the n number of PWMs 51, the LEDs in each of the LED modules generate a plurality of luminance chromaticities in the first period T1.

As shown in FIG. 16, the first LED C₁ to the n^{th} LED Cₙ of the first LED module 11, ℑC₁, C₂, C₃, C₄, . . . , Cₙ₋₁, Cₙ┘, through different operating current combinations of the n number of controllers 52, generate a first luminance intensity in the first period T1. As shown in FIG. 17, the second LED C₂ to the first LED C₁ of the second LED module 12, └C₂, C₃, C₄, . . . , Cₙ₋₁, Cₙ, C₁┘, through different operating current combinations of the n number of controllers 52, generate a second luminance intensity in the first period T1, and so forth. As shown in FIG. 18, the n^{th} LED Cₙ to the (n−1)^{th} LED Cₙ₋₁ of the n^{th} LED module 19, └Cₙ, C₁, C₂, C₃, C₄, . . . Cₙ₋₂, Cₙ₋₁┘, through different operating current combinations of the n number of controllers 52, generate an n^{th} luminance intensity in the first period T1.

Therefore, in the second embodiment of the present invention, through the different operating current combinations of the n number of controllers 52, the LEDs in the LED modules generate a plurality of luminance intensities in the first period T1, respectively.

The first period T1 and a subsequent second period T2 are consecutive operation periods.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A light-emitting diode (LED) module lamp with adjustable chromaticity, formed by at least one set of second module repeatedly connected in series;
wherein:
the second module comprises a plurality of LED modules from a first LED module to an n^{th} LED module, each of the LED modules comprises a plurality of LEDs having visible spectrum chromaticities, and is formed by a structure in a cyclic arrangement of a first chromaticity LED C₁ to an nth chromaticity LED Cₙ;
a chromaticity sequence of the LEDs of the first LED module is the first chromaticity LED C₁, a second LED chromaticity LED C₂, . . . , an (n−1)^{th} chromaticity LED Cₙ₋₁, and the nth chromaticity LED Cₙ; the chromaticity sequence of the first LED module is a first column: └C₁, C₂, C₃, C₄, . . . , Cₙ₋₁, Cₙ┘;
a chromaticity sequence of the LEDs of the second LED module is the second chromaticity LED C₂, the third LED chromaticity LED C₃, . . . , the (n−1)^{th} chromaticity LED Cₙ₋₁, the nth chromaticity LED Cₙ, and the first chromaticity LED C₁; the chromaticity sequence of the second LED module is a second column: └C₂, C₃, C₄, . . . , Cₙ₋₁, Cₙ, C₁┘;
a chromaticity sequence of the LEDs of the n^{th} LED module is the nth chromaticity LED Cₙ, the first chromaticity LED C₁, the second LED chromaticity LED C₂, the third LED chromaticity LED C₃, . . . , and the (n−1)^{th} chromaticity LED Cₙ₋₁; the chromaticity sequence of the n^{th} LED module is an n^{th} column: └Cₙ, C₁, C₂, C₃, C₄, . . . Cₙ₋₂, Cₙ₋₁┘;
a combination array (n×n) of the first LED module, the second LED module, the third LED module, to the n^{th} LED module of the second module is:
$$[ \begin{matrix}{C}_{1} & {C}_{2} & {C}_{3} & & … & {C}_{n - 1} & {C}_{n} \\ {C}_{2} & {C}_{3} & {C}_{4} & … & … & {C}_{n} & {C}_{1} \\ {C}_{3} & {C}_{4} & … & … & {C}_{n} & {C}_{1} & {C}_{2} \\ … & … & … & … & … & … & … \\ {C}_{n} & {C}_{1} & … & … & … & {C}_{n - 2} & {C}_{n - 1}\end{matrix} ] ;$$
and
the first to the n^{th} columns are respectively connected in series, and have equal total rated operating voltages that are equal to the operating voltages of the C₁ to Cₙ chromaticity LEDs added together, respectively; the chromaticity LEDs C₁ to Cₙ at the first column are sequentially connected in series as one group, the chromaticity LEDs C₂ to Cₙ₋₁, Cₙ and C₁ at the second column are sequentially connected in series as one group, the chromaticity LEDs C₃ to Cₙ and Cₙ₋₁ at the third column are sequentially connected in series as one group, and the chromaticity LEDs Cₙ, C₁, C₂ to Cₙ₋₂ and Cₙ₋₁ in the n^{th} column are sequentially connected in series as one group.

2. The LED module lamp with adjustable chromaticity according to claim 1, wherein the at least one set of second module has an input end serving as a starting terminal connected to a first voltage, and an output end serving as an ending terminal connected to a ground potential.

3. The LED module lamp with adjustable chromaticity according to claim 2, a total power supply potential is equal when the first LED module is connected in series with the first LED module and then sequentially connected with the third LED module in series; the total rated operating voltages of the first to the n^{th} columns connected in series are equal to sums of the operating voltages of the chromaticity LEDs C₁ to Cₙ, respectively.

4. The LED module lamp with adjustable chromaticity according to claim 3, further comprising:
an n number of pulse-width modulators (PWMs), each having a second end connected to a ground potential, and a first end connected to the output end of the second module serving as the ending terminal;
wherein, the output end of the second module serving as the ending terminal is an output end of an n sets of independent serial connections.

5. The LED module lamp with adjustable chromaticity according to claim 4, wherein periods of the n number of PWMs are independent, and are an adjustable range of 0% to 100%.

6. The LED module lamp with adjustable chromaticity according to claim 5, further comprising:
an n number of controllers, each having one end connected to a ground potential and one other end connected to the second end of the corresponding PWM;
wherein, the controllers are constant voltage controllers, constant current controllers, or constant voltage and constant current controllers.

7. The LED module lamp with adjustable chromaticity according to claim 6, wherein control currents of the n number of controllers are independently adjustable.

8. The LED module lamp with adjustable chromaticity according to claim 6, wherein:
the first LED C₁ to the n^{th} LED Cₙ, └C₁, C₂, C₃, C₄, . . . , Cₙ₋₁, Cₙ┘, through different work period combinations of the n number of PWMs, generate a first luminance chromaticity in a first period T1;
the second LED C₂ to the first LED C₁, └C₂, C₃, C₄, . . . , Cₙ₋₁, Cₙ, C₁┘, through different work period combinations of the n number of PWMs, generate a second luminance chromaticity in the first period T1; and
the n^{th} LED Cₙ to the first LED Cₙ₋₁, ℑCₙ, C₁, C₂, C₃, C₄, . . . Cₙ₋₂, Cₙ₋₁┘, through different work period combinations of the n number of PWMs, generate an nth luminance chromaticity in the first period T1.

9. The LED module lamp with adjustable chromaticity according to claim 8, wherein:
the first LED C₁ to the nth LED Cₙ of the first LED module, └C₁, C₂, C₃, C₄, . . . , Cₙ₋₁, Cₙ┘, through different operating current combinations of the n number of controllers, generate a first luminance intensity in the first period T1;
the second LED C₂ to the first LED C₁ of the second LED module, └C₂, C₃, C₄, . . . , Cₙ₋₁, Cₙ, C₁┘, through different operating current combinations of the n number of controllers, generate a second luminance intensity in the first period T1; and
the n^{th} LED Cₙ to the (n−1)^{th} LED Cₙ₋₁ of the n^{th} LED module, └Cₙ, C₁, C₂, C₃, C₄, . . . Cₙ₋₂, Cₙ₋₁┘, through different operating current combinations of the n number of controllers, generate an n^{th} luminance intensity in the first period T1.
